(19) United States
(12) Patent Application Publication
(10) Pub. No.: US 2011/0126225 A1
(43) Pub. Date: May 26, 2011

(54) TV, TEXT/WEB FEED AND ADVERTISMENT AGGREGATION SYSTEM

(76) Inventor: Shlomo Turgeman, Ramat Efal (IL)

(21) Appl. No.: 12/623,421

(22) Filed: Nov. 22, 2009

(51) Int. Cl. H04N 7/167

(52) U.S. Cl. 725/31; 725/48; 725/109; 725/91; 725/32

(57) ABSTRACT

A system for aggregating TV content, with text or web feed content and advertisements, including processors that receive EPG (electronic program guide) information from an EPG server, a DGM (digital rights management) server in communication with the processors for communicating encryption keys and entitlement information, and a video server that provides VOD or NVOD (video on demand or near video on demand) information to the processors, the processors, the EPG server, the DGM server and the video server together forming a media aggregation server and playout schedule engine, which outputs an aggregated format for viewing on a screen.

### FIELD OF THE INVENTION

The present invention relates to systems and methods for aggregating TV content, with text or web feed content and advertisements, such as for advertisers that subscribe to the system.

### BACKGROUND OF THE INVENTION

In many stores, live television content is displayed on TV sets in the store for prospective buyers to enjoy and get a feel of the quality of the TV set they are buying.

### SUMMARY OF THE INVENTION

The present invention seeks to provide systems and methods for aggregating TV content, with text or web feed content and advertisements, as is described more in detail hereinbelow. The invention may be used in a variety of applications, such as but not limited to, simultaneously showing advertisements and text or web feeds on the same screen as live TV. In this manner, for example, the store can not only show live TV content, but may also increase its revenues by simultaneously showing advertisements for other stores or manufacturers.

There is thus provided in accordance with an embodiment of the present invention, a system for aggregating TV content, with text or web feed content and advertisements, including processors that receive EPG (electronic program guide) information from an EPG server, a DGM (digital rights management) server in communication with the processors for communicating encryption keys and entitlement information, and a video server that provides VOD or NVOD (video on demand or near video on demand) information to the processors, the processors, the EPG server, the DGM server and the video server together forming a media aggregation server and playout schedule engine, which outputs an aggregated format for viewing on a screen.

In accordance with an embodiment of the present invention the aggregated format includes a plurality of zones.

In accordance with an embodiment of the present invention the zones include a zone that includes a live video schedule.

In accordance with an embodiment of the present invention the zones include a zone that includes images for advertising.

In accordance with an embodiment of the present invention the zones include a zone that includes text or web feeds.

In accordance with an embodiment of the present invention the aggregated format is fed to a DVB (digital video broadcast) and digital signage playout client processor that manages all input data and TV signals, advertising information and subscriber information.

In accordance with an embodiment of the present invention the media aggregation server and playout schedule engine simultaneously shows advertisements and text or web feeds on the same screen as live TV in a first store, whereas the advertisements are from a second store.

In accordance with an embodiment of the present invention the media aggregation server and playout schedule engine allows changing or scheduling the live TV content, advertising content and/or text or web feeds.

### BRIEF DESCRIPTION OF THE DRAWINGS

These and additional constructional features and advantages of the invention will be more readily understood in the light of the ensuing description of embodiments thereof, given by way of example only, with reference to the accompanying drawing wherein:

FIG. 1 is a simplified pictorial block diagram of a system and method for aggregating TV content, with text or web feed content and advertisements, in accordance with an embodiment of the present invention.

### DETAILED DESCRIPTION OF EMBODIMENTS

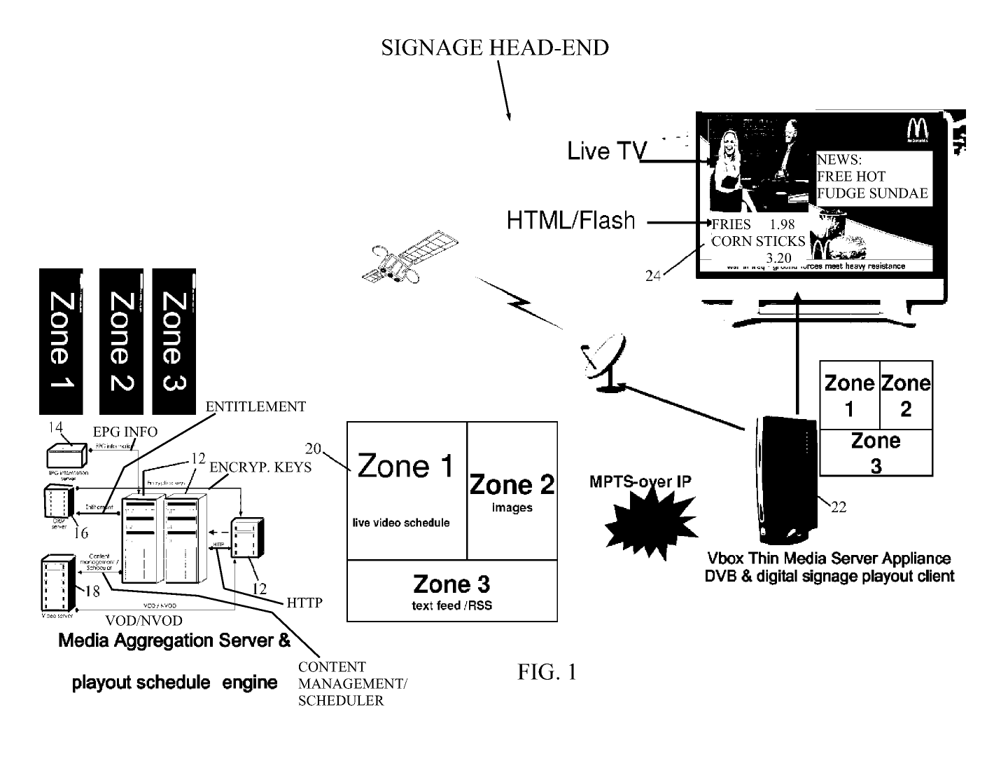

Reference is now made to FIG. 1, which illustrates a system and method for aggregating TV content, with text or web feed content and advertisements, in accordance with a non-limiting embodiment of the present invention.

The system includes various servers or processors 12 for receiving EPG (electronic program guide) information, such as from an EPG server 14. A DGM (digital rights management) server 16 may be in communication with the servers or processors 12 for communicating encryption keys and entitlement information. A video server 18 may provide VOD or NVOD (video on demand or near video on demand) information to servers or processors 12. The servers or processors 12, EPG server 14, DGM server 16 and video server 18 together form a media aggregation server and playout schedule engine, which processes the input information and outputs an aggregated format 20 for viewing on a TV screen and the like. The aggregated format 20 includes, for example, three zones, zone 1, zone 2 and zone 3 (the invention is not limited to this number or format). Zone 1, for example, includes a live video schedule, such as a live TV program or web cast. Zone 2, for example, includes images for advertising and the like. Zone 3, for example, includes text or web (e.g., RSS) feeds.

The aggregated format 20 is fed, e.g., via MPTS over IP (multi-protocol transport stream over Internet protocol), to a DVB (digital video broadcast) and digital signage playout client processor 22, a processor or server that manages all the input data and TV signals (e.g., terrestrial, satellite, cable, subscriber, etc.), advertising information and subscriber information. The final formatted information is displayed on a screen 24.

The invention may be used in a variety of applications, such as but not limited to, simultaneously showing advertisements and text or web feeds on the same screen as live TV. In this manner, for example, the store can not only show live TV content, but may also increase its revenues by simultaneously showing advertisements for other stores or manufacturers.

For example, a multiplicity of stores in a city, country or in a plurality of countries, may subscribe to the system. Each store may store in the system advertising information (video and audio, for example). For example, a pizzeria in a particular location may wish to show live TV content in zone 1 and offer advertising space in zone 2 and/or zone 3 to other stores, such as neighboring appliance stores, laundromats, restaurants, auto parts stores, etc. The system of the invention coordinates the information to be displayed on the screen and collects fees from the stores. The pizzeria's revenues for providing the advertising space may be paid by the system or directly by the stores who advertise in these spaces.

The media aggregation server and playout schedule engine of the system may be structured to allow changing or scheduling the live TV content, advertising content and/or text or web feeds. For example, the pizzeria may be provided with a remote control (or similar device) for changing the live TV content from one type of content during the morning hours to another kind in the evening hours. The same holds true for the advertisements and text/web feeds. This way the system can schedule content better suited for the clientele at different times of the day or year.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A system for aggregating TV content, with text or web feed content and advertisements, comprising:
processors that receive EPG (electronic program guide) information from an EPG server;
a DGM (digital rights management) server in communication with said processors for communicating encryption keys and entitlement information; and
a video server that provides VOD or NVOD (video on demand or near video on demand) information to said processors, said processors, said EPG server, said DGM server and said video server together forming a media aggregation server and playout schedule engine, which outputs an aggregated format for viewing on a screen.

2. The system according to claim 1, wherein said aggregated format comprises a plurality of zones.

3. The system according to claim 2, wherein said zones comprise a zone that includes a live video schedule.

4. The system according to claim 2, wherein said zones comprise a zone that includes images for advertising.

5. The system according to claim 2, wherein said zones comprise a zone that includes text or web feeds.

6. The system according to claim 1, wherein said aggregated format is fed to a DVB (digital video broadcast) and digital signage playout client processor that manages all input data and TV signals, advertising information and subscriber information.

7. The system according to claim 1, wherein said media aggregation server and playout schedule engine simultaneously shows advertisements and text or web feeds on the same screen as live TV in a first store, whereas the advertisements are from a second store.

8. The system according to claim 1, wherein said media aggregation server and playout schedule engine allows changing or scheduling the live TV content, advertising content and/or text or web feeds.
